(19) United States
(12) Patent Application Publication
(10) Pub. No.: US 2012/0133511 A1
(43) Pub. Date: May 31, 2012

(54) METHOD AND APPARATUS FOR DETECTING CONTROL PANEL ATTACKS IN A SECURITY SYSTEM

(75) Inventors: William R. Blum, Huntington Station, NY (US); Robert J. Orlando, Nesconset, NY (US); Gordon G. Hope, Miller Place, NY (US); Alfred M. Lizza, Oyster Bay, NY (US)

(73) Assignee: Honeywell International Inc., Morristown, NJ (US)

(21) Appl. No.: 12/955,189

(22) Filed: Nov. 29, 2010

(51) Int. Cl. G08B 13/00

(52) U.S. Cl. 340/541

(57) ABSTRACT

A method and apparatus for detecting intruders. The method includes the steps of a control panel of a security system detecting an intrusion of a secured area, the control panel entering a delay period before reporting the intrusion in order to allow entry of a disarm code through a control panel disposed on a structural surface proximate an entrance to the secured area, a sensor monitoring the control panel for movement and the control panel reporting the intrusion before expiration of the delay period upon detecting movement.

### FIELD OF THE INVENTION

The field of the invention relates to security systems and more particularly to methods of defeating security systems.

### BACKGROUND OF THE INVENTION

Security systems are generally known. Such systems typically include some form of physical barrier to intruders including one or more sensor to detect intruders who are able to surmount the barrier.

In the case of a home, the physical barrier may be the exterior walls of the home. In this case, the sensors may include door sensors that detect the opening or closing of the doors. Window sensors may also be provided to detect intruders who attempt to enter through a window.

The sensors within a home are typically electrical switches that are mechanically connected to a door or window. In other cases, motion detectors may be used that are based upon infrared detection of human intruders or the processing of video signals to detect human shapes.

The control panel typically operates in three modes including disarmed, armed and armed stay. In the disarmed state, the control panel does not report a burglary alarm when a sensor is activated, while in the armed state the control panel sounds an alarm when a sensor is activated and may report the alarm to a central monitoring station. In the armed stay (used during night time hours when a homeowner is present), the control panel may only monitor sensors along a periphery of the home.

While alarm systems are effective, the control panel may still be vulnerable to attack in some cases. If the criminal can disable the control panel, then entry by a criminal may not be reported. Accordingly, a need exists for better ways of protecting the control panel of security systems.

### BRIEF DESCRIPTION OF THE DRAWING

FIG. 1 depicts an alarm system shown generally in accordance with an illustrated embodiment of the invention.

### DETAILED DESCRIPTION OF AN ILLUSTRATED EMBODIMENT

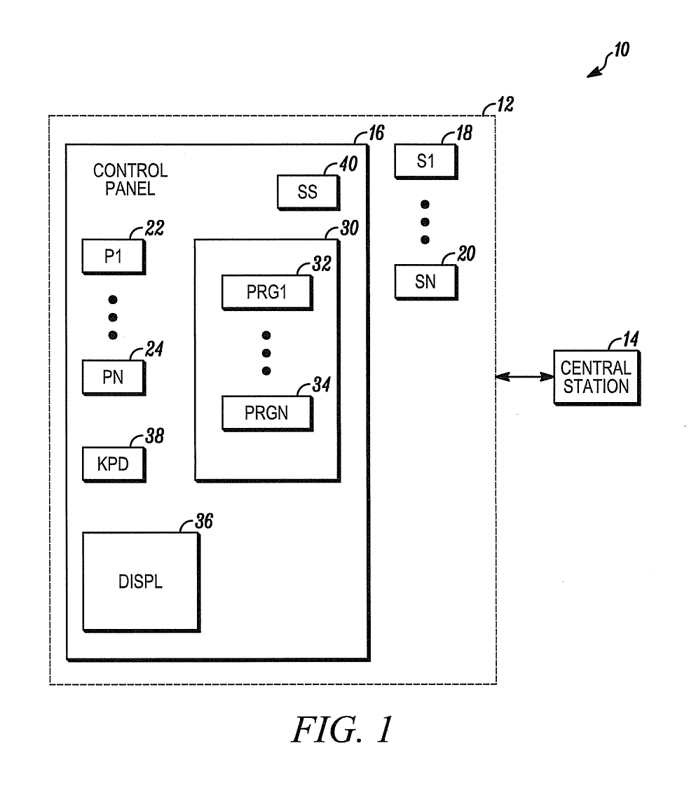

FIG. 1 is a block diagram of a single panel (self contained) security system 10 shown generally in accordance with an illustrated embodiment of the invention. Single panel security systems 10 are different than distributed panel control security systems because all the sensors are connected to the single panel. Similarly, the control of the security system 10 is accomplished through a keypad and display located on the single control panel.

Single panel security systems 10 are more susceptible to physical attack because the processing features of such systems are limited to only a single panel. For example, single panel security systems 10 are typically located near an entrance to a secured area. Located on the panel is a keypad that allows entry of a code to arm and disarm the security system 10. When an authorized party enters the secured area, the single panel security system may detect entry of an intruder, but does not immediately generate an alarm because the security system is programmed and has to allow time for an authorized party to enter a disarm code through the keypad.

Criminals may use this feature to defeat such security systems. In this case, a criminal may enter the secured area and then physically attack, disable or destroy the single panel of such security systems. If the criminal is able to disable the processing or communication features of the security system, then an alarm will never be sent to a central monitoring station thereby creating the situation equivalent to the secured area having no protection at all.

Turning now to a description of the invention, FIG. 1 shows a single panel security system 10. In this regard, the single control panel 16 of the security system 10 is located within a secured area 12. Upon detection of an intruder within the secured area 12, the security system 10 is programmed to compose and send the alarm to a central station monitoring station 14. In such cases, the central monitoring station 14 sends private security personnel or notifies the local police department of the intrusion.

The panel 16 of the security system 10 includes one or more programmed processors 22, 28 operating under control of computer software (i.e., computer code). The computer code includes a number of programs 32, 34 residing in a non-transitory computer readable medium 30.

The security system 10 includes a number of intrusion sensors 18, 20 within or along a periphery of the secured area 12. The sensors 18, 20 may be electrical switches that detect the opening of a door or window or may be motion detectors that detect motion within the secured area 12.

At least one of the programmed processors 22, 24 operates as a status processor that detects entry of a code through a keyboard 38 of the security system 10 and that causes the alarm system 10 to enter a predefined state based upon the entered code. The entered code may include an alarm-away code defining an alarm-away state, a disarm code defining a disarmed state and an alarm-stay code defining an alarm-stay state. The current state of the alarm panel 16 may be indicated by text shown on a display panel 36.

At least one other of the programmed processors 22, 24 (or one of the programs 32, 34 operating on the same processor) operates as an intrusion detection processor based upon the state of the alarm system 10. For example, the intrusion detection processor may monitor all of the sensors 18, 20 when the alarm system 10 is in the alarm-away state and only the perimeter sensors 18, 20 when the alarm system 10 is in the alarm-stay state.

Another one of the programmed processors 22, 24 (or the same processor) operates as an alarm reporting processor. In this case, whenever the intrusion detection processor detects activation of a monitored sensor 18, 20, the intrusion detection processor transfers notification thereof to the alarm reporting processor. The alarm reporting processor composes an alarm packet for transfer to the central monitoring station 14. The alarm reporting processor may delay transfer of the alarm packet to the central monitoring station pending receipt of an authorization signal.

The intrusion detection processor 22, 24 may also transfer notification of intrusion to a reporting or entry delay processor 22, 24. The delay processor may operate to delay transfer of the alarm packet to the central monitoring station 14. In this case, the reporting delay processor may delay sending the alarm packet for a predetermined time period (e.g., 30 seconds) in the case of the alarm-away state in order to allow an authorized user to enter an disarm (alarm off) code through the keypad 38. At the end of the predetermined time period and in the absence of entry of the disarm code, the reporting delay processor transfers the authorization signal to the reporting processor and the reporting processor responds by transferring the alarm packet to the central monitoring station. Alternatively, if the status processor 22, 24 detects entry of the disarm code before the end of the predetermined time period, then the status processor cancels the alarm or otherwise deactivates the alarm processor.

Also included within the alarm panel 16 is a movement or vibration detector 40. The movement detector 40 may be directly coupled to the structure of the alarm panel 16.

The movement detector 40 detects physical attacks on the alarm panel 16 within the secured space. The movement detector 40, in turn, may be coupled to a movement processor 22, 24 within the alarm panel 16.

The movement detector 40 may be a shock sensor or an accelerometer coupled to a movement processor 22, 24. Upon detection of movement, the movement processor 22, 24 generates an authorization signal causing the reporting processor 22, 24 to end the entry delay and immediately send the alarm packet to the central monitoring station 14.

As would be well known to those of skill in the art, a shock sensor may be a mechanical device that directly detects impact while an accelerometer detects and measures acceleration. If the sensor 40 is an accelerometer, then the movement processor 22, 24 measures an acceleration based upon the signal from the sensor 40 and compares the measured value with a threshold value. If the measured value exceeds the threshold value, then the processor 22, 24 generates the authorization signal.

While the sensor 40 could be either a shock sensor or accelerometer, any combination of sensors could be used. For example, a shock sensor, accelerometer or even a limit switch could be used in combination to detect different types of attacks on the alarm panel 16.

In another embodiment, the sensor 40 may be used to detect a physical attack on the alarm panel 16 without the necessity of first detecting an intrusion. In this case, the movement sensor 40 may be coupled to the alarm reporting processor in the same manner as a perimeter sensor 18, 20. This may be important where a criminal is able to enter the secured area 12 without tripping a perimeter sensor 18, 20. In this case, there would be no entry delay since the sensor 40 would concurrently trigger the alarm reporting processor and generate an authorization signal.

The use of the movement sensor 40 on the alarm panel 16 may considerably improve the effectiveness of the security system 10. For example, if an intruder should attempt to pry open the security panel 16, the sensor 40 would immediately detect the movement caused by the prying efforts and immediately trigger the alarm.

Similarly, if the intruder should attempt to smash the alarm panel 16, then the first blow would trigger the alarm. However, the first blow may not be completely effective to disable the security system 10 an alarm may still be reported before subsequent blows disable the panel 16.

A specific embodiment of method and apparatus for detecting intruders has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method comprising:
a control panel of a security system detecting an intrusion of a secured area;
the control panel entering a delay period before reporting the intrusion to a central monitoring station in order to allow entry of a disarm code through a control panel where the control panel is disposed on a structural surface proximate an entrance to the secured area;
a sensor monitoring the control panel for movement; and
the control panel reporting the intrusion before expiration of the delay period upon detecting movement.

2. The method as in claim 1 further comprising defining the sensor as a vibration sensor.

3. The method as in claim 2 further comprising measuring the vibration of the control panel.

4. The method as in claim 3 further comprising comparing the measured vibration with threshold value.

5. The method as in claim 1 further comprising defining the sensor as a shock sensor.

6. The method as in claim 1 further comprising periodically monitoring the control panel any time the security system is in an armed mode.

7. The method as in claim 6 further comprising and reporting an alarm anytime the control panel is armed and the detector detects movement.

8. An apparatus comprising:
means within a control panel of a security system for detecting an intrusion of a secured area;
means within the control panel for entering a delay period before reporting the intrusion in order to allow entry of a disarm code through a control panel proximate an entrance to the secured area;
means within the control panel for monitoring the control panel for movement; and
means within the control panel for reporting the intrusion before expiration of the delay period upon detecting movement.

9. The apparatus as in claim 8 wherein the means for monitoring for movement further comprises a shock sensor.

10. The apparatus as in claim 9 wherein the means for monitoring for movement further comprises an accelerometer that measures acceleration of the control panel.

11. The apparatus as in claim 10 further comprising a programmed processor that compares the measured acceleration with threshold value.

12. The apparatus as in claim 8 wherein the means for monitoring movement further comprises a shock sensor.

13. The apparatus as in claim 8 further comprising a programmed processor that periodically monitors the control panel for movement any time the security system is in an armed mode.

14. The apparatus as in claim 13 further comprising a programmed processor that reports an alarm anytime the control panel is armed and the means for detecting movement detects movement.

15. An apparatus comprising:
a control panel of a security system that detects an intrusion within a secured area and where the control panel enters a delay period before reporting the intrusion in order to allow entry of a disarm code through a control panel;
a sensor that monitors the control panel for movement; and
a programmed processor within the control panel that reports the intrusion before expiration of the delay period upon detecting movement via the sensor.

16. The apparatus as in claim 15 wherein the sensor further comprises a shock sensor.

17. The apparatus as in claim 15 wherein the sensor further comprises an accelerometer.

18. The apparatus as in claim 17 further comprising a programmed processor that comparing the measured vibration with a threshold value.

19. The apparatus as in claim 15 further comprising a programmed processor that periodically monitors the control panel for movement any time the security system is in an armed mode.

20. The apparatus as in claim 19 further comprising a programmed processor that reports an alarm anytime the control panel is armed and the detector detects movement.
